(19) United States
(12) Patent Application Publication
(10) Pub. No.: US 2015/0158404 A1
(43) Pub. Date: Jun. 11, 2015

(54) VEHICLE SEAT SUSPENSION

(71) Applicants: VIKTOR PYLYPENKO, DNIPROPETROVSK (GB); OLEG PYLYPENKO, DNIPROPETROVSK (GB); MAKSIM PYLYPENKO, DNIPROPETROVSK (GB)

(72) Inventors: VIKTOR PYLYPENKO, DNIPROPETROVSK (GB); OLEG PYLYPENKO, DNIPROPETROVSK (GB); MAKSIM PYLYPENKO, DNIPROPETROVSK (GB)

(21) Appl. No.: 14/100,246

(22) Filed: Dec. 9, 2013

(51) Int. Cl. B60N 2/52; B60N 2/50

(52) U.S. Cl. CPC B60N 2/525; B60N 2/501; B60N 2/502

(57) ABSTRACT

The invention is related to an unified means for protection of vehicle operators against shock and vibration troubling influences arising from the bearing base of the seat.

The seat suspension includes an articulated guiding mechanism, an air resilient element with supply main line (15), a seat support platform (1) and a bearing base (2). The guiding mechanism has two rigidly connected crossed linkages each consisting of a pair of two levers (3, 4). The air resilient element is arranged to interact with the platform (1) and the base (2) around a pair of hinges and to form an integral air-resilient-damping mechanism, including two chambers. An improvement is achieved by using a controller (16) of the nominal seat position arranged to disconnect of inflation and drainage while unloading the seat and a controller (13) of rigidity and relative damping arranged to connect the volume (V₁) with volume (V₂).

### FIELD OF THE INVENTION

The present invention relates to machine-building, and can be used as a unified means for protection of operators of transport vehicles (trolleybuses, tractors, trucks, buses, and the like) as well as constructional, road-building and agricultural vehicles, against shock and vibration troubling influences arising from the bearing base of the seat.

### BACKGROUND ART

It is known a suspension of the operator seats for the transport; construction and agricultural vehicles comprising a suspension support platform, a guiding mechanism, resilient type elements, and fluid dampers, (SU, 1594010). However such suspensions cannot provide the necessary transfer characteristics for a “machine base—man” system and therefore the appropriate comfort conditions for an operator.

It is known also an operator seat suspension comprising a resilient type element made in the form of a rubber-cord balloon filled with a pressed air, such as, for instance, a tractor seat suspension made by of the “Magnum” company. Such a seat suspension ensures the necessary transfer characteristics of the “machine base—man” system but has a rather complicated structure and is expensive, since in addition to the parts of seat suspension and an air-resilient element it contains also the hydraulic dampers.

UA, 64036 discloses an air suspension having significantly simplified structure in a comparison with the device of the “Magnum” suspension due to combining into one mechanism the functions of the air-resilience of the suspension and the damping of seat oscillations without using hydro-air dampers.

However under operation of the driver's seat there are no possibilities to vary the rigidity and relative damping (aperiodicity coefficient) of the suspension.

The most relevant document of the prior art is UA, 74313 which discloses an vehicle seat suspension.

The technical solution proposed by UA, 74313 also does not allow to adjust the rigidity and relative damping (aperiodicity coefficient) of the suspension, as well as to adjust the nominal seat position.

As a result when the load on the seat, at the same seat occupant, changes, the seat deviations from its nominal position will occur.

### SUMMARY OF THE INVENTION

The object of the present invention is to eliminate the drawbacks of the vehicle seat suspension of the type disclosed in UA, 74313.

The common substantial features of the subject-matter of the claimed invention and the vehicle seat suspension known from the UA, 74313 are as follows: an articulated guiding mechanism, an air resilient element having an air supply main line, a seat support platform and a bearing base of the vehicle. Said articulated guiding mechanism has two rigidly connected linkages each consisting of a pair of crossed levels articulated in the middle. Each one end of one pair of levels is articulated with the bearing base and each other end of this pair is connected with the seat support platform by means of a longitudinal guide. Vise versa, each one end of the other pair of levels is articulated with the seat support platform and the other end is connected with the bearing base by means of the other longitudinal guide. The air resilient element is arranged to interact with the support platform and the bearing base around a pair of suitable hinges so as to form an integral air-resilient-damping mechanism, including two chambers, one of which has a constant volume (V₂) and another—a variable volume (V₁). The chamber of the variable volume (V₁) is formed by a part of a movable body and a plunger with an axial conduit (14), hermetically connected with each other by a rubber-cord sleeve (11) to form a closed circuit

Distinctive features of the claimed suspension are such that the constant volume chamber and variable volume chamber are connected between them by a controller of rigidity and relative damping (aperiodicity coefficient), and that an axial conduit of the plunger (piston) is connected with an air supply main line of the vehicle by means of a controller of the nominal seat position arranged to disconnect of inflation and drainage while unloading the seat.

These features of the claimed invention enable to significantly increase the effectiveness of damping of the oscillations of the operator seat, since they allow, at the same suspension structure, to change the resonance frequency of oscillation and the relative damping with the purpose of using a suspension for a certain vehicle.

### BRIEF DESCRIPTION OF THE DRAWINGS

In the following, the substance of the invention will be explained in more details with references to the accompanying drawings, in which schematically are shown:

FIG. 1—a general side view of the claimed suspension;

FIG. 2—a general plan view (along A-A of FIG. 1);

FIG. 3—a general view of the air-resilient-damping mechanism;

FIG. 4—a general view of the controller of rigidity and relative damping;

FIG. 5—a general view of the controller of nominal seat position;

FIG. 6—a transfer characteristic of the “vehicle base—operator” systems.

### BEST MODE FOR CARRYING OUT OF THE INVENTION

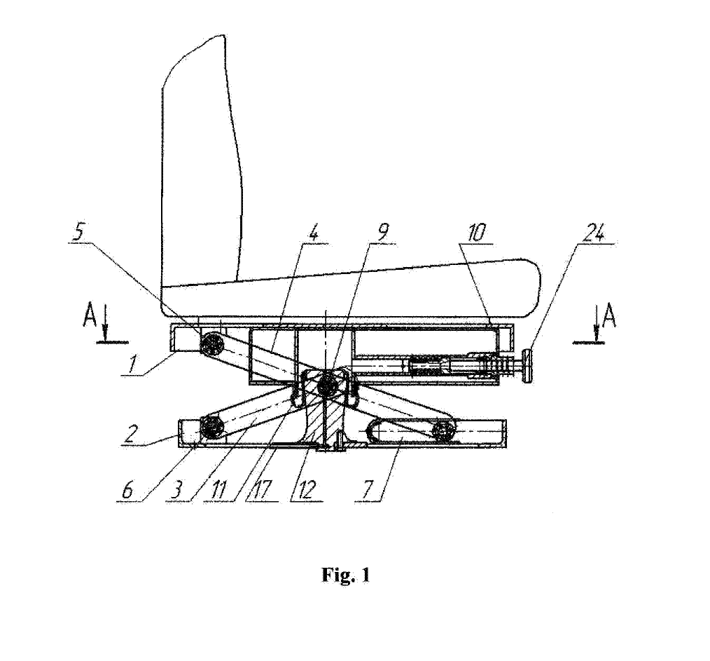

The vehicle seat suspension of the invention, as shown on FIG. 1 includes a seat support platform 1 which rests upon the bearing base 2 of the suspension through the articulated guiding mechanism. The articulated guiding mechanism includes two rigidly connected linkages each having a pair of crossed levers 3 and 4 connected in the middle by an articulated connection 9. Levers 3 at one ends are connected each with an articulated connection 6 of the bearing base 2, and at the other ends each—with a longitudinal guide 8 fixed on the support platform 1 of the seat, and vice versa: the pair of levels 4 at one ends are connected each with an articulated connection 5 fixed on the support platform 1 of the seat, and at the other ends each—with a longitudinal guide 7 fixed on the bearing base 2 of the proposed suspension.

A movable body 10 by means of a rubber-cord envelope 11 is communicated with a fixed plunger 12 mounted on the bearing base 2.

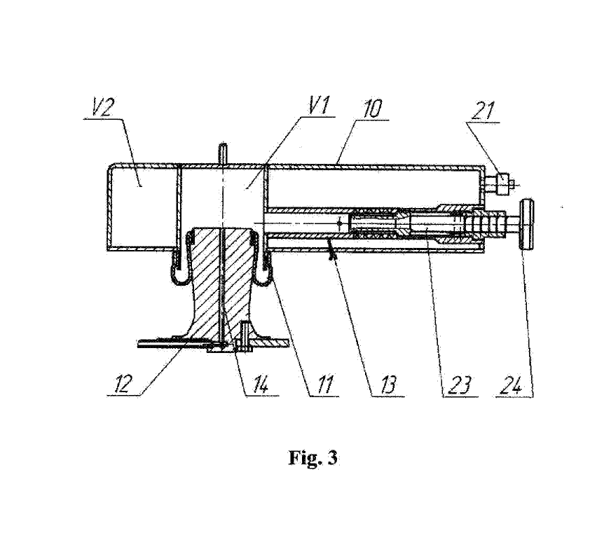

The movable body 10 can be made in such a way that there two chambers can be formed—one of which having a variable volume V₁ and the other—a constant volume V₂ (as described in UA, 64036), or only the chamber with a variable volume V₁, while the chamber with the volume V₂ be made separately and disposed on the bearing base 2 or near the bearing base 2. Under operation of the suspension of the invention, the air, regardless of the dispositions of the volumes V₁ and V₂, overflows from one volume into another through the controller 13 (FIG. 3) of the rigidity and relative damping, which provides a required rigidity (resonance frequency of oscillations and relative damping of the suspension) for a certain vehicle.

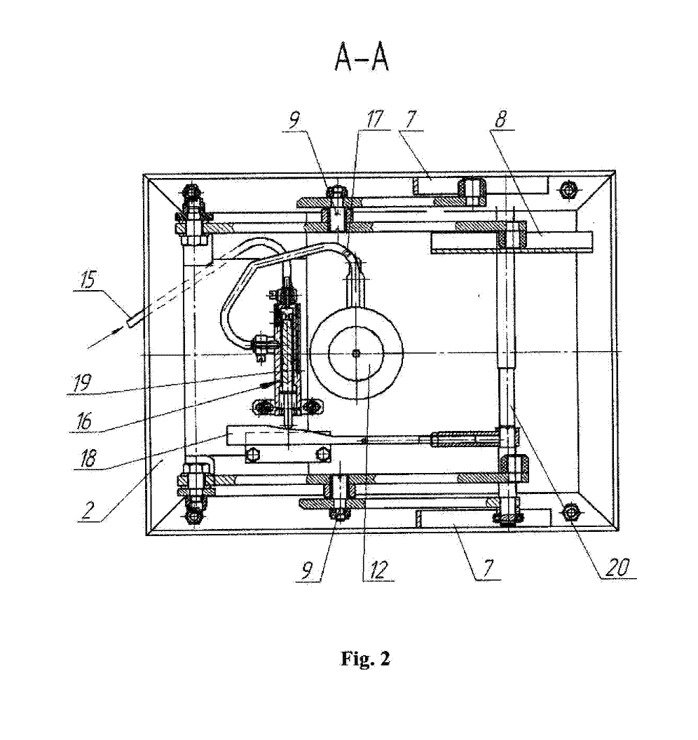

An axial conduit 14 is arranged in the plunger 12 for supplying the air through an air supply main line 15 (FIG. 2) by means of a controller 16 of the nominal seat position to settle a necessary pressure in the seat suspension within a wide range of changes of the anthropometric data of a seat occupant.

The vehicle seat suspension of the invention functions as follows. The controller 16 (FIG. 2) of the nominal seat position is in state of connection with the air system of the vehicle (not shown) through the air supply main line 15, and with the conduit 14 (FIG. 3) of the plunger 12 through the air supply main line 17 (FIG. 2).

Depending on the operator's weight, the controller 16 of the nominal seat position provides a necessary pressure in the seat suspension by means of displacement of a profiled plate 18 relative to the rod 19 of the controller 16 of the nominal position by means of a driver 20 which pins together the low ends of the pairs of level 4 (FIG. 1) mounted in the guides 7.

When the seat becomes unloaded, the seat suspension stretches entirely, and the profiled plate 18 (FIG. 2) ensures the position of the rod 19 of the controller 16 in which the inflation (supply) and drainage of the air from the resilient-damping mechanism are eliminated.

If the seat of the invention is occupied by an operator weighing less than for the previous case, for which the unloading of the seat had occurred, the controller 16 of the nominal seat position will not be able to start functioning itself. Thereto the operator should press a knob of the drainage valve 21 (FIG. 3).

As a result, the air pressure in the suspension will be reducing, and the controller 16 (FIG. 2) of the nominal position provides a necessary pressure for the operator of a lesser weight.

If the last operator is weighing more than it occurs for the previous case, then there is no necessity to press the knob of the drainage valve 21, since the controller 16 of the nominal position provides automatically the pressure necessary for a new operator, by means of displacement of the profiled plate 18 and setting the rod of the controller 19 in the nominal position.

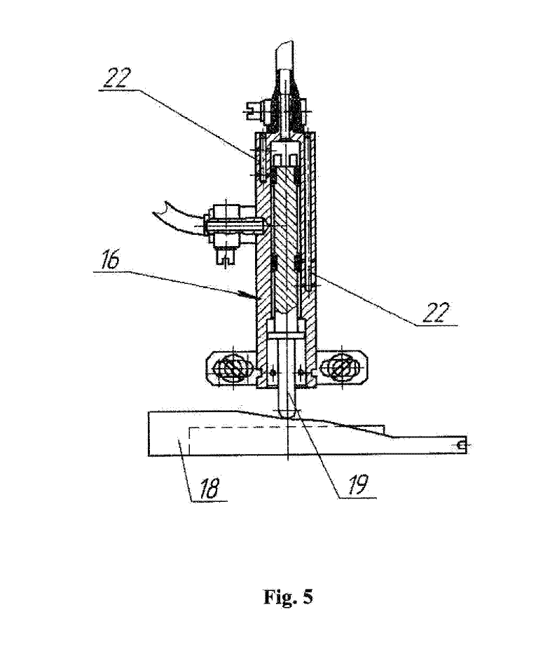

In the range of the nominal position, the suspension has a quasi-zero rigidity (the soft seat). This allows considering the suspension as being set into a position close to the nominal one. In further functioning the seat, the air content in the suspension remains almost constant, because as the suspension is squeezing or stretching, the conduits 22 (FIG. 5) of the controller 16 enter into functioning, providing the air inflation at squeezing or the air drainage at stretching the suspension, and therefore the relative displacements of the suspension are carried out near the nominal position.

At movement of the vehicle, the bearing base 2 of the suspension can carry out the vertical non-periodic or near non-periodic oscillations in the range of quasi-zero rigidity of the suspension, an operator being almost entirely protected against influence of dynamic loadings. The controller 13 of rigidity and relative damping in the range of quasi-zero rigidity ensures a damping of oscillations and a required comfortable transfer characteristic of the “vehicle bearing base—operator” system.

By means of selection of suitable constructive characteristics of the suspension, such as volumes V₁ and V₂, configurations of the plunger 12 and rubber-cord envelope 11, one can get a necessary minimum natural frequency of oscillations within the wide limits of variations of the operator's anthropometric data When the controller 13 of rigidity and relative damping is set between the volumes V₁ and V₂ in a position of maximum communicating cross-sections along with a selected static characteristic the optimum transfer coefficient of the “vehicle bearing base—operator” system at a minimum natural frequency of oscillations of the seat suspension is achieved.

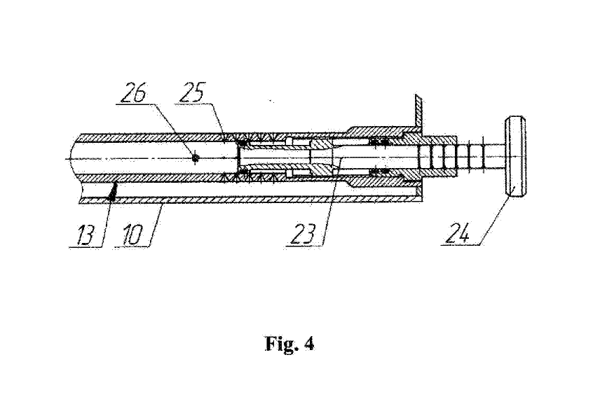

To obtain higher values of the natural frequency of oscillations of the seat suspension and of the necessary relative damping coefficient ξ₀=0,5), the rod 23 (FIG. 3) of the controller 13 by means of a fly-wheel 24 is displaced in a position which ensures a required reducing of the communicating cross-sections of the jet orifices 25 (FIG. 4) of the controller 13, while to obtain the maximum natural frequency less than 1 Hz, the displacement of the rod 23 involves entire closing of all the ranks of the jet orifices 25 of the controller 13. The orifice 26 remains working for overflowing the air between the volumes V₁ and V₂.

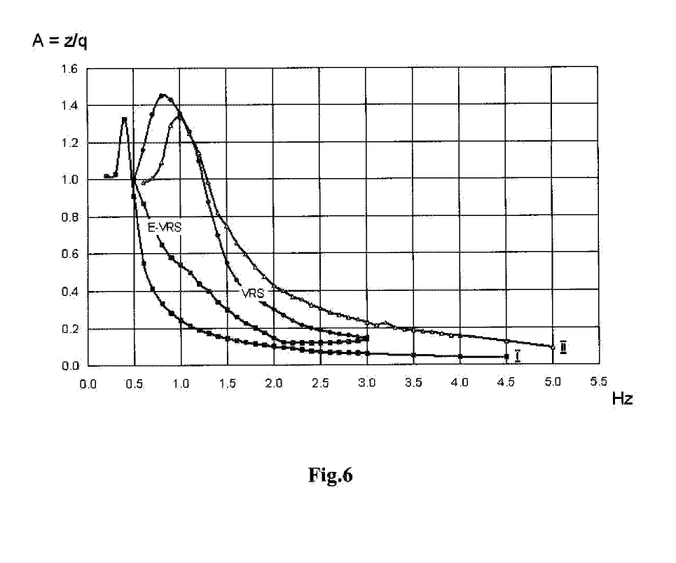

FIG. 6 shows the amplitude-frequency characteristics (transfer characteristics of the system), which represents the dependence of a relative value A=z/q (a relative value of the amplitude z of the oscillations of the seat occupying operator to the amplitude q of oscillations of the bearing base equipped with the vibroprotective systems of the Sears Co., semi-active VRS or active E-VRS, or with the claimed suspension comprising controller 13 of a rigidity and aperiodicity coefficient) on frequency Hz for two positions of the rod 23 of the controller 13: I—with the fully opened jet orifices 25, and II—with the fully closed jet orifices 25 in all the ranks of the rigidity controller.

In last case, the air overflow between the volumes V₁ and V₂ is passed only through the orifice 26.

The obtained results demonstrate that:
when the orifices in all the ranks are fully opened, the transfer characteristic of the vibroprotective system of the invention is better than the characteristic of the significantly more complex Sears E-VRS active vibroprotective system;
when the orifices in all the ranks are fully closed, the natural frequency of oscillations of the seat increases from 0,4 to 1 Hz; hence, the rigidity increases by 6,25 times, and aperiodicity coefficient remains constant ξ₀=0,6.

Using of the distinctive features of the invention, namely the controller of rigidity and relative damping and the controller of a nominal seat position arranged so that to disconnect of inflation and drainage while unloading the seat allow to improve the operating characteristic of the suspension known from UA, 74313.

1. A vehicle seat suspension including an articulated guiding mechanism, an air resilient element having an air supply main line (15), a s seat support platform (1) and a bearing base (2) of the vehicle, said articulated guiding mechanism having two rigidly connected crossed linkages each consisting of a pair of two levers (3,4) articulated in the middle wherein each one end of levels (3) is articulated with the bearing base (2) and each other end of levels (3) is connected with the seat support platform (1) by means of a longitudinal guide (8), and, vice versa, each one end of levels (4) is articulated with the seat support platform (1) and each other end of levels (4) is connected with the bearing base (2) by means of a longitudinal guide (7), said air resilient element being arranged to interact with the support platform (1) and the bearing base (2) around a pair of suitable hinges to form an integral air-resilient-damping mechanism (10,11,12), including two chambers, one of which has a constant volume (V₂) and another—a variable volume (V₁), the chamber of the variable volume (V₁) being formed by a part of a movable body (10) and a plunger (12) having an axial conduit (14), the chamber of the variable volume (V₁) and the plunger (12) being hermetically connected with each other by a rubber-cord sleeve (11) to form a closed circuit characterized in that said suspension further comprises a controller (16) of a nominal seat position arranged so as to disconnect inflation and drainage while unloading the seat, connected with the axial conduit (14) of the plunger (12) and with the air supply main line 15, and a controller (13) of a rigidity and relative damping arranged to connect the chamber of the variable volume (V₁) with the chamber of the constant volume (V₂).
